(19) United States
(12) Patent Application Publication
(10) Pub. No.: US 2010/0228534 A1
(43) Pub. Date: Sep. 9, 2010

(54) METHOD, SYSTEM AND COMPUTER PRODUCT FOR PLANNING NEEDLE PROCEDURES

(75) Inventors: Pinhas GILBOA, Haifa (IL); Uri Shreter, Mequon, WI (US)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ActiViews Ltd., Haifa (IL)

(21) Appl. No.: 12/553,246

(22) Filed: Sep. 3, 2009

Related U.S. Application Data
(63) Continuation-in-part of application No. PCT/IL2008/000272, filed on Mar. 3, 2008.
(60) Provisional application No. 60/892,845, filed on Mar. 3, 2007.

(51) Int. Cl. G06G 7/48

(52) U.S. Cl. 703/11

(57) ABSTRACT

A system and method for planning a needle procedure include designating a target location within three-dimensional image data of a subject's body and defining a tentative route for insertion of a needle to the target location. The three-dimensional image data is processed to generate a graphic representation which indicates whether the tentative route intersects an obstacle of at least one type. In response to a user input, the graphic representation is then rotated about axes passing through the target location, thereby allowing selection of an updated route to the target which does not intersect an obstacle.

This is a continuation in part of PCT Application No. PCT/IL08/000,272 filed Mar. 3, 2008.

### FIELD AND BACKGROUND OF THE INVENTION

The present invention relates to Image-Guided needle systems and, in particular, it concerns a system and method for planning the route of the needle in the body.

Needle tools are often used in the medical field to deliver local treatment or take diagnostic samples. In recent years, these procedures are typically carried by interventional radiologists, physicians who are experts in using imaging devices for guiding and controlling diagnostic and therapeutic procedures. In these procedures, the needles are inserted into the body under control of the imaging device. Computer Tomography (CT) and Magnetic Resonance Imaging (MRI) are the preferred imaging devices for guiding a needle to intrabody target.

The following description relate to the use of CT in guiding needles to intrabody targets. MRI can be used in a similar manner. In order to align the CT coordinates with the body of the patient, a laser projector projects a line on the body of the patient. This line corresponds to the image slice, whose axial coordinate is displayed on a display adjacent to the bed of the CT system. Determination of the entry point of the needle is currently performed as follows. An opaque bar is placed on the body of the patient. A scan is performed, and the location of the target is determined by its axial coordinates and the distance between a point on the bar and the entry point. The bed is moved until its coordinates, as displayed on the bed coordinates, are equal to the entry point axial coordinate. The entry point is marked on the skin along the laser projected line at distance from the bar as measured from the CT data. The bar is removed and the needle is guided to the target using the CT images. The preference of clinicians in the majority of procedures currently performed is to choose an entry point in the same axial CT slice as the target location in order to facilitate intuitive planning of the needle route using the axial CT image. This, however, is overly limiting, and is not always possible.

When obstacles in the route force the clinician to guide the needle at an angle to the slices, more than one slice becomes relevant to guiding the needle, and the above described method is inadequate for planning the route of the needle in a way that avoids the obstacles.

U.S. Pat. No. 6,064,904 to Yanof et al. describes a system using a stereotactic mechanical arm assembly in a needle procedure planning stage. The system provides various oblique views which are taken along planes parallel to the needle direction. While potentially helpful in assessing what lies in the planned route of the needle, these views to not relate intuitively to volume or surface features of the body. In the absence of a stereotactic mechanical arm assembly, the system does not provide an intuitive manner for identifying the intended entry point of the needle on the skin surface.

There is therefore a need for a method and system to assist a clinician in planning and executing needle procedures.

### SUMMARY OF THE INVENTION

The present invention is a system, method and computer-readable medium for planning a needle procedure in which a needle is to be inserted from an entry point to an intra-body target within the body of a subject.

According to the teachings of the present invention there is provided, a system for planning a needle procedure in which a needle is to be inserted from an entry point to an intra-body target within the body of a subject, the system comprising: (a) a display; (b) a user input device; and (c) a processor system associated with the display and the user input device, the processor system including at least one processor.

According to a further aspect of the present invention, there is provided a computer readable medium having stored thereon computer readable program code for planning a needle procedure in which a needle is to be inserted from an entry point to an intra-body target within the body of a subject.

Execution of the aforementioned program code by a computer and/or the aforementioned processor system and/or the method of the present invention are configured to perform the following steps: (a) inputting three-dimensional image data of the body; (b) designating within the three-dimensional image data a target location; (c) defining a tentative route for insertion of the needle to the target location; (d) processing the three-dimensional image data to generate a first graphic representation of the image data for presentation to a user, the first graphic representation being indicative of whether the tentative route intersects an obstacle of at least one type; and (e) responsive to a user input, generating at least one additional graphic representation of the image data for presentation to the user, the additional graphic representation being related to the first graphic representation by rotation about at least one axis passing through the target location such that a position of the target location within the graphic representations is substantially constant, thereby allowing selection of an updated route to the target which does not intersect an obstacle of the at least one type.

According to a further aspect of the present invention, execution of the aforementioned program code by a computer and/or the aforementioned processor system and/or the method of the present invention are configured to perform the following steps: (a) inputting three-dimensional image data of the body; (b) designating within the three-dimensional image data a target location; (c) defining a tentative route for insertion of the needle to the target location; (d) processing the three-dimensional image data to generate a first graphic representation of the image data for presentation to a user, the first graphic representation corresponding to a view taken substantially parallel to the tentative route in which at least a first type of tissue is rendered transparent, thereby indicating whether the tentative route intersects an obstacle of at least a second type of tissue; and (e) responsive to a user input, generating at least one additional graphic representation of the image data for presentation to the user, the additional graphic representation being related to the first graphic representation by rotation about at least one axis passing substantially through the target location such that the additional graphic representation corresponds to a view taken substantially parallel to an updated route for insertion of the needle to the target, thereby indicating whether the updated route intersects an obstacle of at least the second type of tissue.

According to a further feature of the present invention, the three-dimensional image data is of a type selected from the group consisting of CT data and MRI data.

According to a further feature of the present invention, the obstacle is a non-penetrable tissue type.

According to a further feature of the present invention, the obstacle is a penetrable internal organ.

According to a further feature of the present invention, the tentative route and the updated route are straight lines from a needle entry point to the target.

According to a further feature of the present invention, a needle entry point is determined corresponding to a point of intersection between the updated route and a skin surface identified from the three-dimensional image data.

According to a further feature of the present invention, at least one reference point identifiable on the skin surface is identified in the three-dimensional image data, and a distance from the at least one reference point to the needle entry point is determined.

According to a further feature of the present invention, the reference point corresponds to a marker applied to the skin of the subject prior to sampling of the three-dimensional image data.

According to a further feature of the present invention, the needle entry point is marked on the skin of the user by measuring the distance from the at least one reference point.

According to a further feature of the present invention, an output is generated indicative of an angle of deployment of at least part of an imaging system for which the updated route lies within an imaging plane of the imaging system

### BRIEF DESCRIPTION OF THE DRAWINGS

The invention is herein described, by way of example only, with reference to the accompanying drawings, wherein:

FIG. 1 is a schematic isometric view of a system, constructed and operative according to the teachings of the present invention, for planning a needle procedure.

FIG. 2 is a screenshot illustrating a display during marking a target according to a first example of the present invention.

FIG. 3 is a screenshot similar to FIG. 2 after centering the target of the first example.

FIG. 4 is a screenshot showing volume rendering of the target of the first example.

FIG. 5 is a screenshot showing a tentative planned route for the first example blocked by a rib.

FIG. 6 is a screenshot showing a final unobstructed planned route of the needle for the first example.

FIG. 7 is a screenshot showing determination of the entry point for the first example.

FIG. 8 is a screenshot showing the marking of a reference in the first example and determination of instructions for marking the entry point on the skin of the patient.

FIG. 9 is a schematic description of instructions for marking of the entry point for the first example.

FIG. 10 is a screenshot illustrating a display during marking of a target according to a second example.

FIG. 11 shows the centering of the display of the selected target in the second example.

FIG. 12a is a screenshot showing a volume rendering 3D image for the second example.

FIG. 12b is a screenshot showing a tentative route for the needle in the second example which would pass through a major blood vessel.

FIG. 13 is a screenshot illustrating a final unobstructed route for the second example.

FIG. 14 is a screenshot showing determination of the needle entry point for the second example.

FIG. 15 is a screenshot illustrating the marking of a reference point for the second example and determination of the instructions for marking the entry point on the skin of the patient.

FIG. 16 is a schematic description of the instructions for marking the entry point in the second example.

FIG. 17 is a schematic isometric view illustration a marker used optionally to assist in marking the entry point on the skin of the patient.

### DESCRIPTION OF THE PREFERRED EMBODIMENTS

The present invention is a system, method and computer-readable medium for planning a needle procedure in which a needle is to be inserted from an entry point to an intra-body target within the body of a subject.

The principles and operation of systems and methods according to the present invention may be better understood with reference to the drawings and the accompanying description.

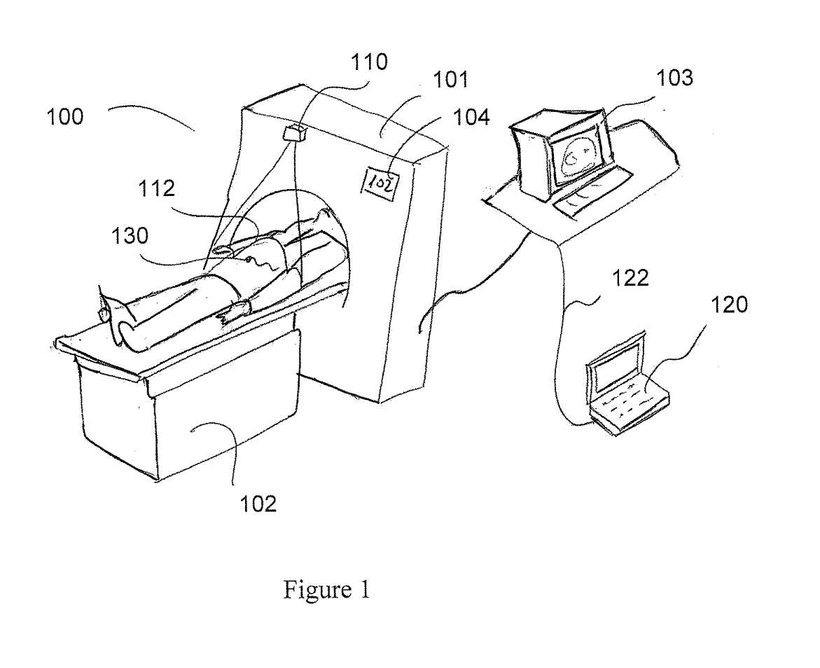

Referring now to the drawings, FIG. 1 shows a general view of a system 100, constructed and operative according to the teachings of the present invention, for planning a needle procedure in which a needle is to be inserted from an entry point to an intra-body target within the body of a subject. In this case, system 100 is implemented as part of a CT system including a scanner 101, a CT bed 102 and a control unit 103. An optical line projector 110 projects a line 112 on the body of the patient. The projected line is a projection, on the body of the patient, of the location of the CT slice of which the coordinates are displayed on a display 104. A computer 120 is connected via a connection line 122 to the CT system. Computer 120 is used to plan the route of the needle in the body of the patient. Computer 120 is preferably a personal computer, although other implementations of a processing system also fall within the scope of the present invention. In one preferred embodiment of the invention, connection line 122 is a USB communication line. In another preferred embodiment of the invention, connection line 122 is PACS network. Other types of communication between computers are applicable in this invention as well. In certain cases, computer 120 may be integrated with CT control unit 103. Computer 120 typically contains a processing system including at least one processor, electronic storage to hold the CT scanned data, a software program for calculating the needle route, a graphic card to calculate and display three dimensional (3D) images and a display to display the resulting images. Optionally, a dedicated reference marker 130, visible under CT imaging, is attached to the patient's skin to assist marking the entry point on the skin of the patient accurately.

The patient is laid on the CT bed. Marker 130 is optionally attached to his or her skin at an estimated neighborhood to the target. If needed, contrast agent is injected to the patient in purpose to enhance the appearance of blood vessels in the CT images. A scan is performed, and the resulted images are fed to computer 120.

The route of a needle in the body is, for the purpose of the present invention, typically assumed to be essentially a straight line that connects the entry point to the target. The present invention serves as a tool to assist the clinician to choose an entry point which defines a route that leads from the entry point to the target without intersecting obstructions, such as vital organs or non-penetrable obstacles. This tool preferably combines some or all of the following capabilities:
a. to display images of a volume as reconstructed from a 3D imaging device such as CT or MRI;
b. to identify and calculate the location of an intrabody target;
c. to calculate and display a volume representation of selected body organs;
d. to define a straight line (tentative route) in the volume of the imaging data that passes through the target;
e. to rotate the displayed images around the target;
f. to display the straight line in such a manner as to facilitate checking whether the line intersects an intrabody obstacle;
g. to define an entry point for the needle as the intersection of the line with the skin of the patient as defined by the envelope of the body reconstructed from the 3D imaging data; and
h. to measure the distance from said entry point to one or more reference points defined in said volume images.

Thus, in general terms, the method of the present invention, corresponding to the operations performed by the system of the present invention, typically includes inputting three-dimensional image data of the body and designating within that image data a target location. A tentative route for insertion of the needle to the target location is then defined, either by a user input or in an automated or arbitrary manner (for example, assuming a vertically downwards tentative suggestion for the needle insertion route). The three-dimensional image data is then processed to generate a graphic representation indicative of whether the route intersects an obstacle of at least one type. According to the particularly preferred implementation presented herebelow, the graphic representation corresponds to a view taken substantially parallel to the planned route in which at least a first type of tissue is rendered transparent. This graphic representation gives an intuitive indication at so whether the planned route intersects an obstacle of at least a second type of tissue. The system then allows the clinician to rotate the graphic representation around at least one axis passing through the target location such that the position of the target location within the graphic representation is substantially constant, thereby allowing selection of an updated route to the target which does not intersect an obstacle of the second type of tissue.

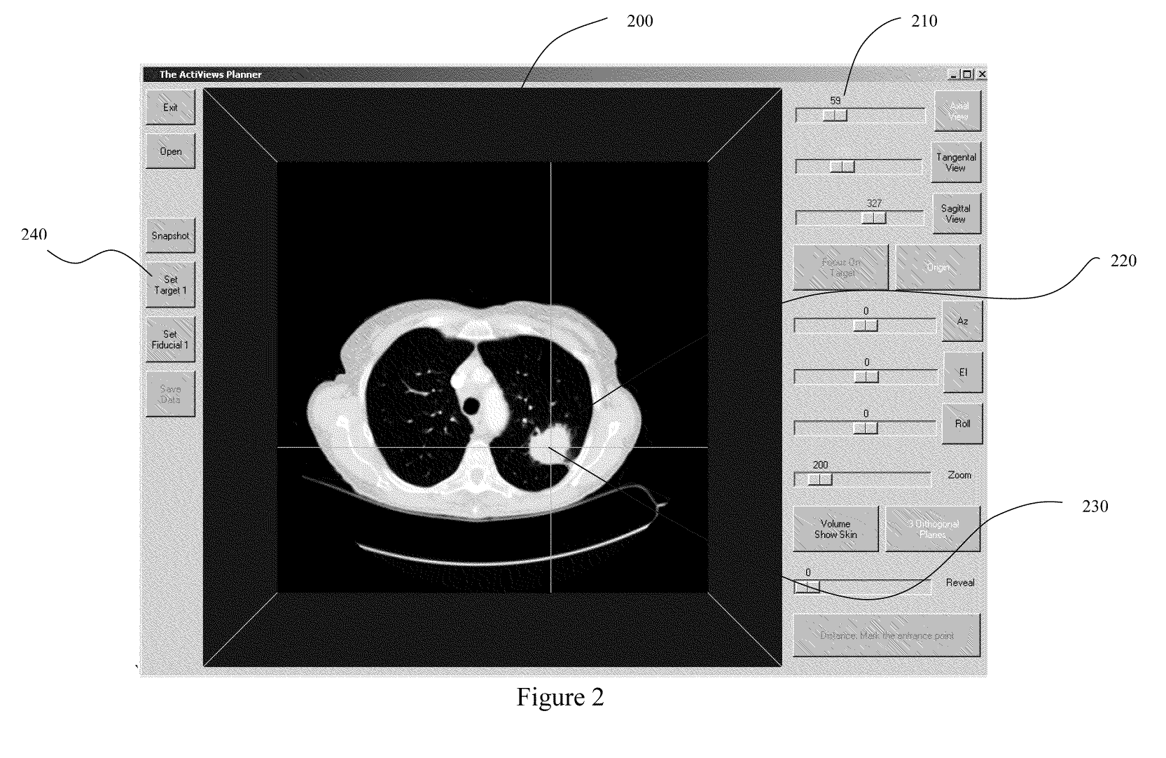

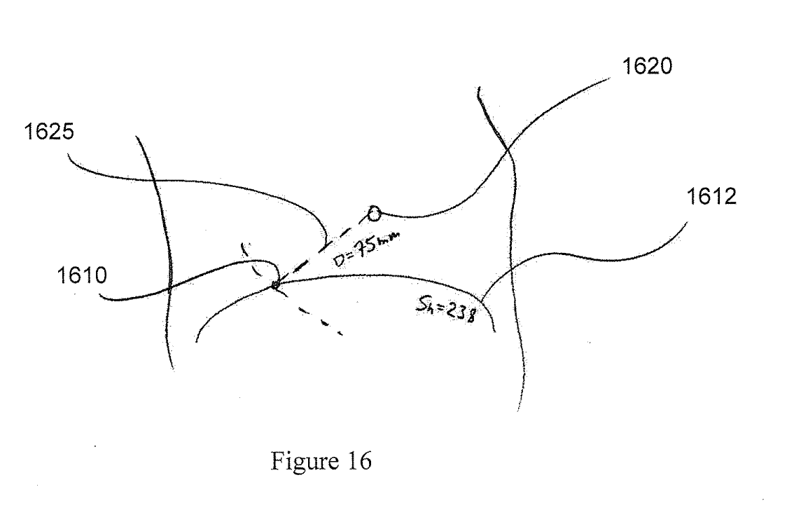

These principles will be understood more fully from two examples which will now be described with reference to FIGS. 2 to 17. FIGS. 2 to 9 describe how to use the herein device to plan a route which avoids obstacles along the path.

First, the clinician defines the target. Computer 120 includes a viewer and planner application, typically implemented as a software product stored on a computer readable medium which when executed suitably configures computer 120 to perform the various functions which will be described. The viewer generates a graphic user interface on a display, for example as illustrated by the screenshot of display 200 in FIG. 2 which displays the patient's CT image slices. With slider 210, the clinician can control what slice is displayed. By pointing and clicking the mouse on the image, a point in 3D coordinates is set and displayed as a green crosshair 230. The clinician searches for the target using slider 230 until the center of the target appears in the display 200. By clicking the mouse at the center of the target, the 3D coordinates of the target are set. Button 240 stores the location of the cursor as target.

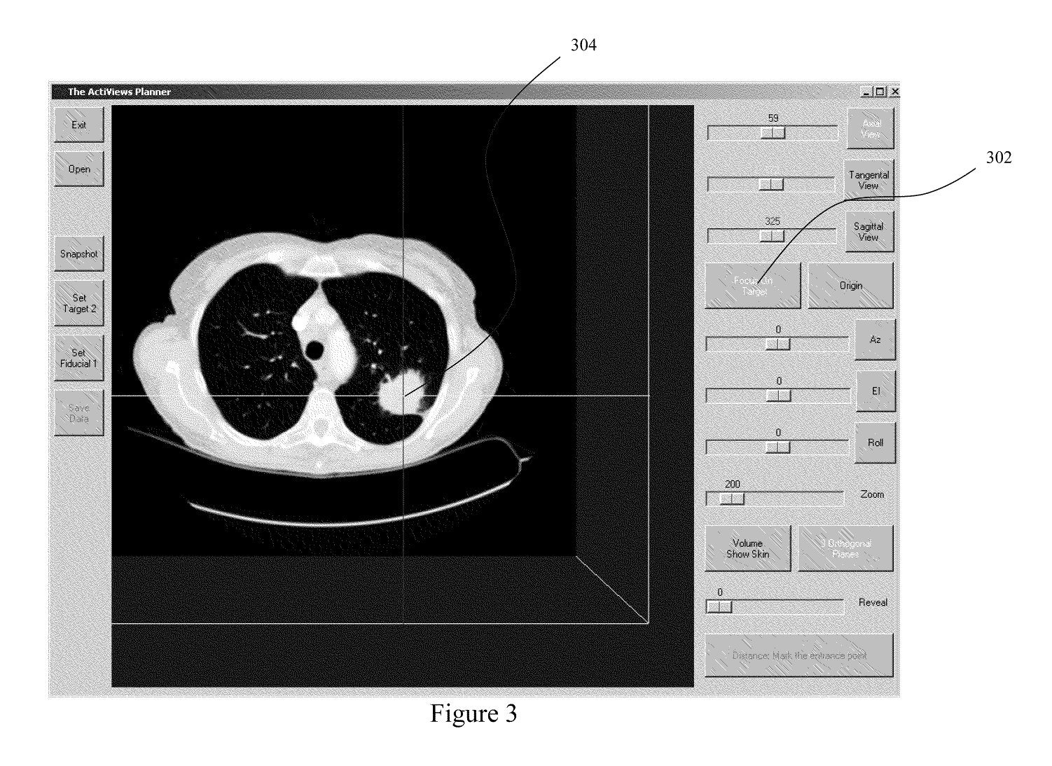

Next, the target is set as the center of rotation. This is done by clicking button 302, “Focus on Target”, which defines the target coordinates as the center of rotation (point 304 in FIG. 3). It brings the target to be located along the line of sight (L.O.S.) of the image processing virtual camera, typically also centered on the screen display.

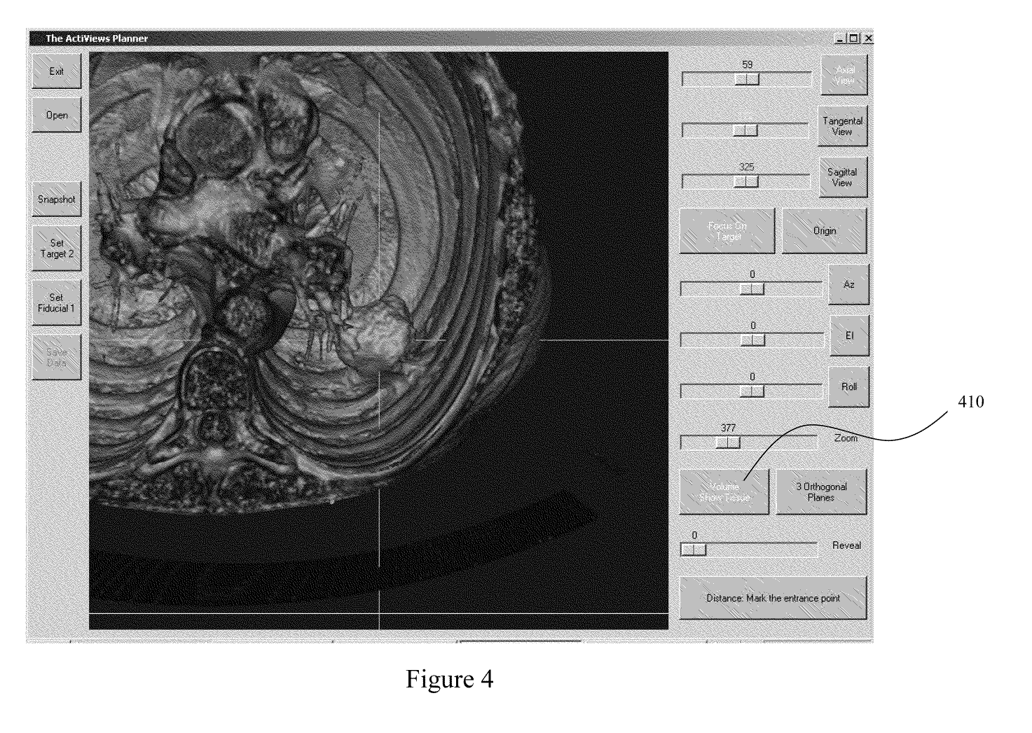

A volume rendering image of the body is then generated. This display is, in the case shown here, activated by clicking on the “Volume” button 410. Different volume rendering parameters can be selected in purpose to display different body organs. In FIG. 4, for instance, the selected rendering parameters are chosen to show the lesion without its surrounding tissue. Various techniques are known for implementing such volume rendering. One non-limiting example is the open-source Visualization Tool Kit (“VTK”) C++ class library, freely available from various sources including Kitware Inc. (New York, USA).

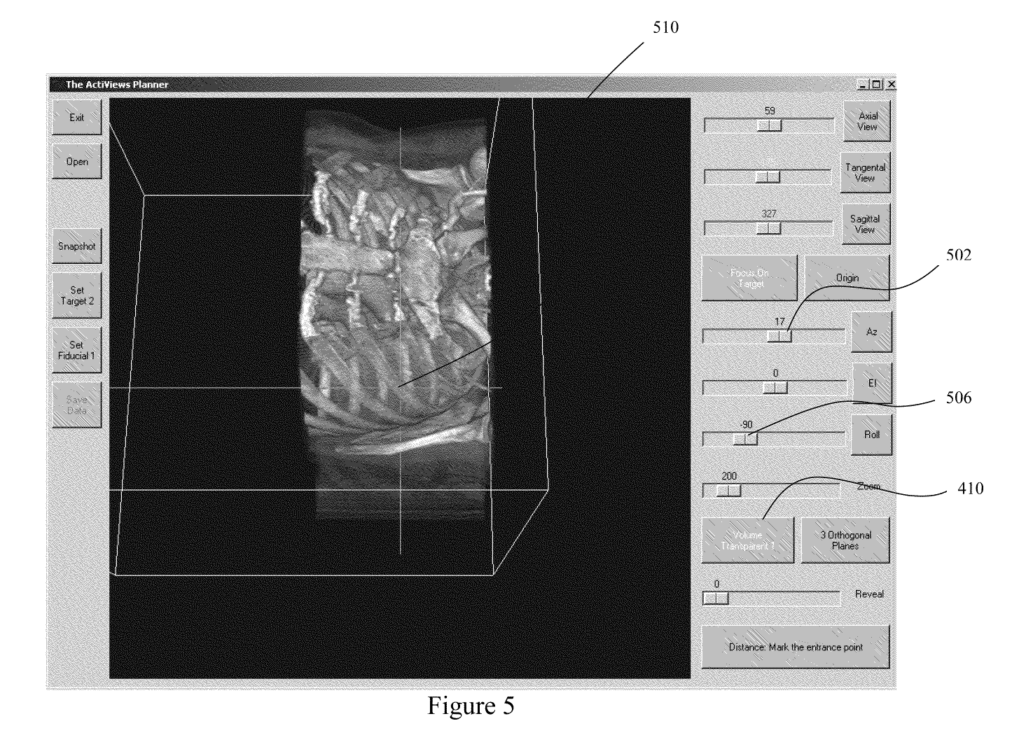

The clinician then uses the system to identify obstacles along the route of the needle. In the example shown in FIG. 5, the parameters of the volume rendering are selected to show a partially-transparent image of the body. In other words, certain types of body tissue, in this case having lower X-ray absorbance, is rendered completely or partially transparent, while other tissue types, in this case having higher absorbance or otherwise defined, are rendered opaque. The parameters for the opaque tissue types are preferably chosen to correspond to predefined tissue types which are defined as “obstacles” for the needle procedure. In the present example, this is primarily “non-penetrable” tissue such as bone. The tissue is referred to herein as “non-penetrable” in the sense that a needle of typical dimensions introduced without excessive force will not succeed in penetrating the tissue. In other cases, such as the second example discussed below, the “obstacles” may include penetrable tissue of internal organs which are to be avoided during the procedure. Optionally, additional visual aids, such as color differentiation between different opaque tissue types, and shadow or other lighting effects to enhance three dimensional perception, may be employed.

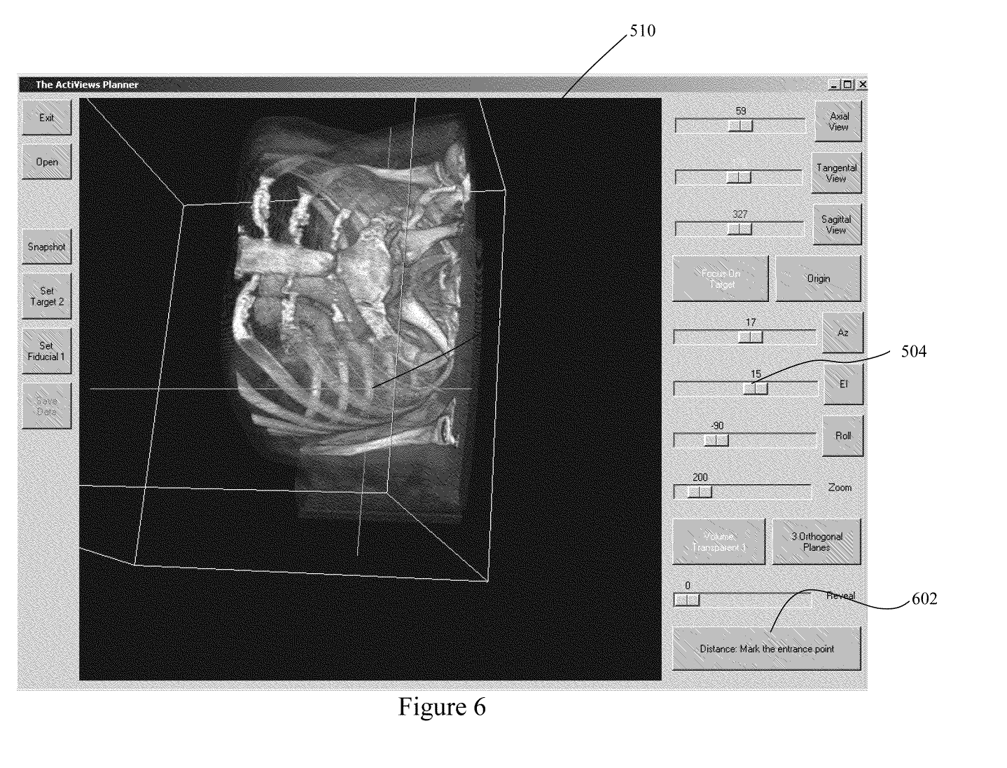

Using slider 502 for azimuth and slider 506 for roll, the image of the body is rotated around axes of rotation passing through (or near) the target. The image volume is rotated around point 510 and brought to the orientation chosen by the clinician as the optimal for inserting the needle and guiding it to target. In the embodiment of the invention shown in these examples, the planned route of the needle is defined as the line of sight directed towards the center of the crosshair. In other words, the currently proposed route for insertion of the needle corresponds to the viewing direction currently presented to the clinician. Obstacles, if present, intersect with the L.O.S., thereby obscuring the target, or a symbol or crosshair intersection indicative of the target position. In the example shown in FIG. 5, the initial chosen orientation is not adequate, since, as seen in the image, a rib interferes with the planned path. Using the elevation slider 504, the image is further rotated, as shown in FIG. 6, until no other obstacle is found to interfere with the planned route.

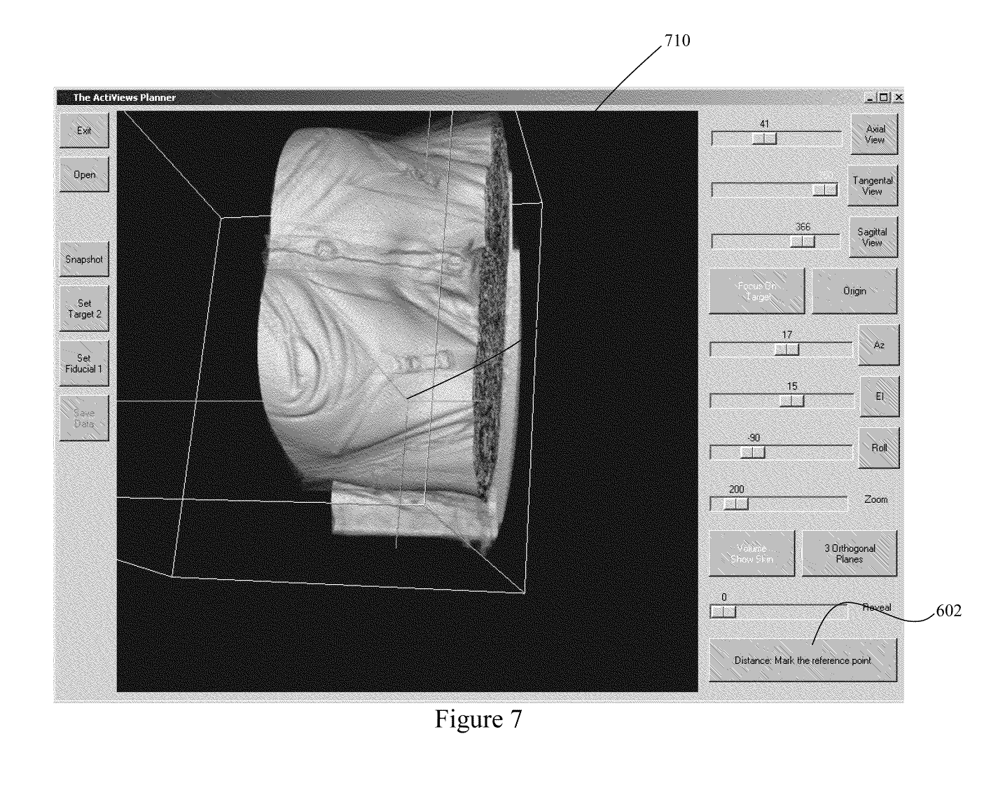

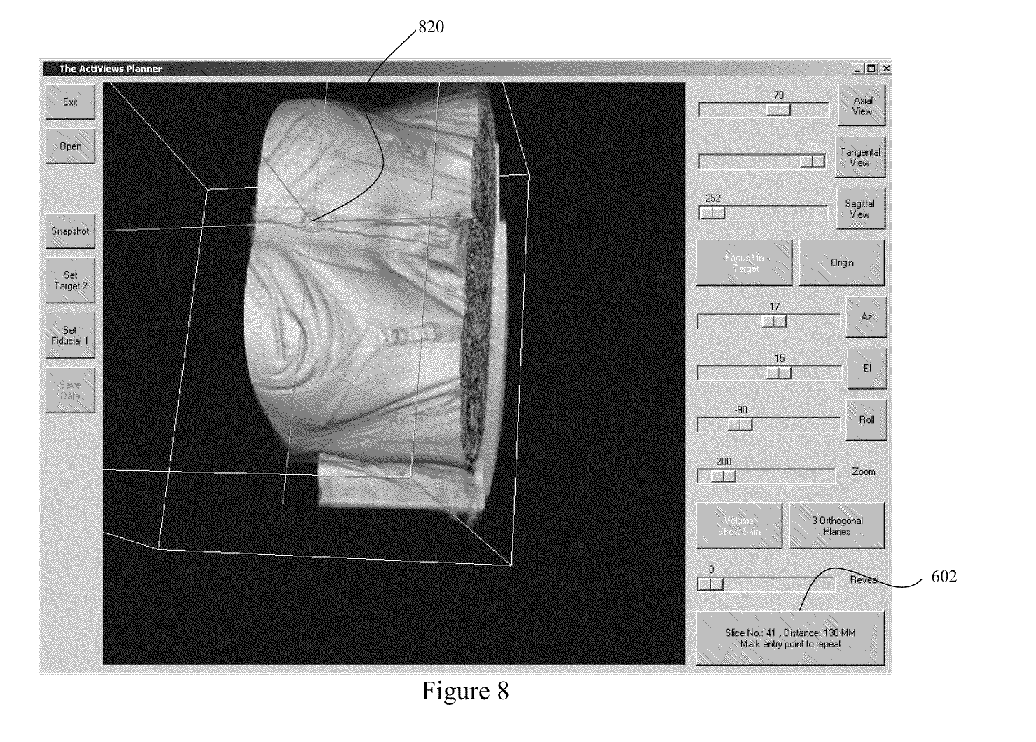

Once a route for insertion of the needle has been chosen, the entry point is determined. Activation of button 602 as shown in FIG. 6 activates the entry-point marking stage, as illustrated in FIG. 7. The parameters of the volume rendering are changed to display the skin. The entry point 710 is determined by the intersection of the L.O.S. with the skin. To assist the marking of the selected entry point on the skin of the patient, distance the between one or more reference points and the entry point should be determined. The reference is selected by pointing the mouse on the image of the reference (point 820 in FIG. 8) and clicking button 602. The coordinates of the defined entry point is displayed on button 602: slice number 41 and distance 130 mm from the reference point in the example shown in FIG. 8.

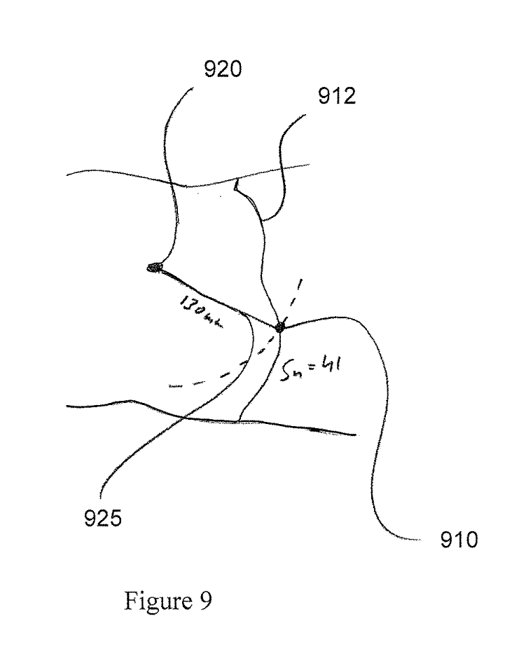

As shown in FIG. 9, the planned entry point can then be marked on the skin of the patient. According to the aforementioned results in this example, the intersection between slice number 41 and distance of 130 mm, measured from the reference point, defines the entry point and should be marked on the skin of the patient. This is accomplished by moving the bed until slice number 41 is displayed on display 104. Projector 110 projects a line 912, which is now identical to slice number 41, on the chest of the patient. The clinician measures with a ruler a radius of 130 mm from reference point 920. The entry point is the intersection 910 of the measured radius with the projected line.

As an alternative to the use of line projector, a second reference point can be used, where the entry point is defined by the intersection of the two radiuses, each measured from its own point of reference.

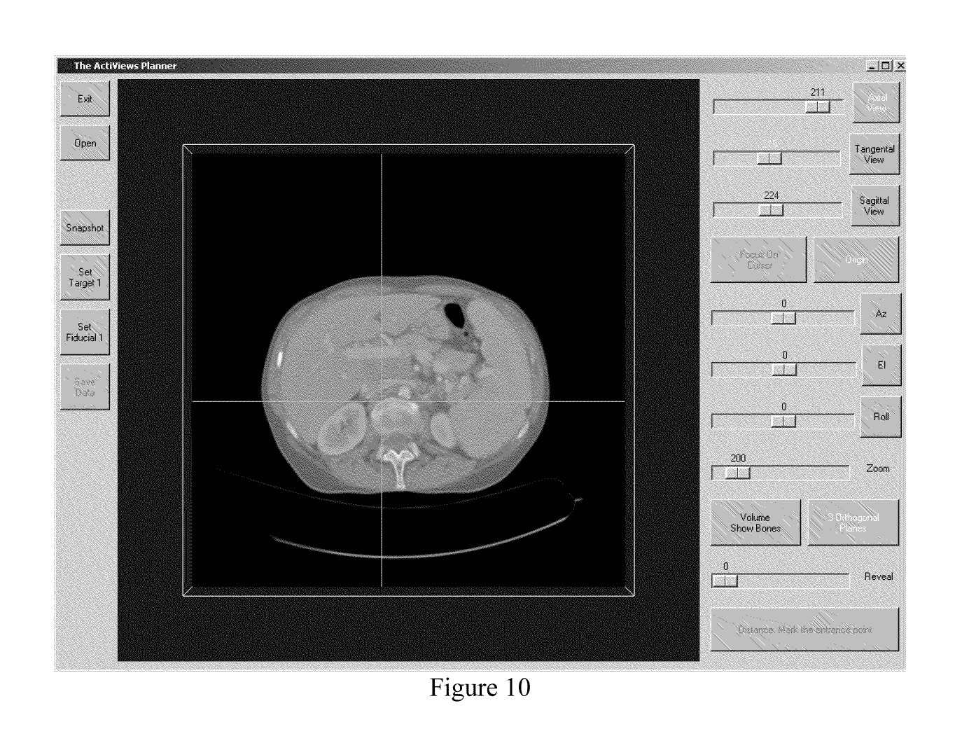

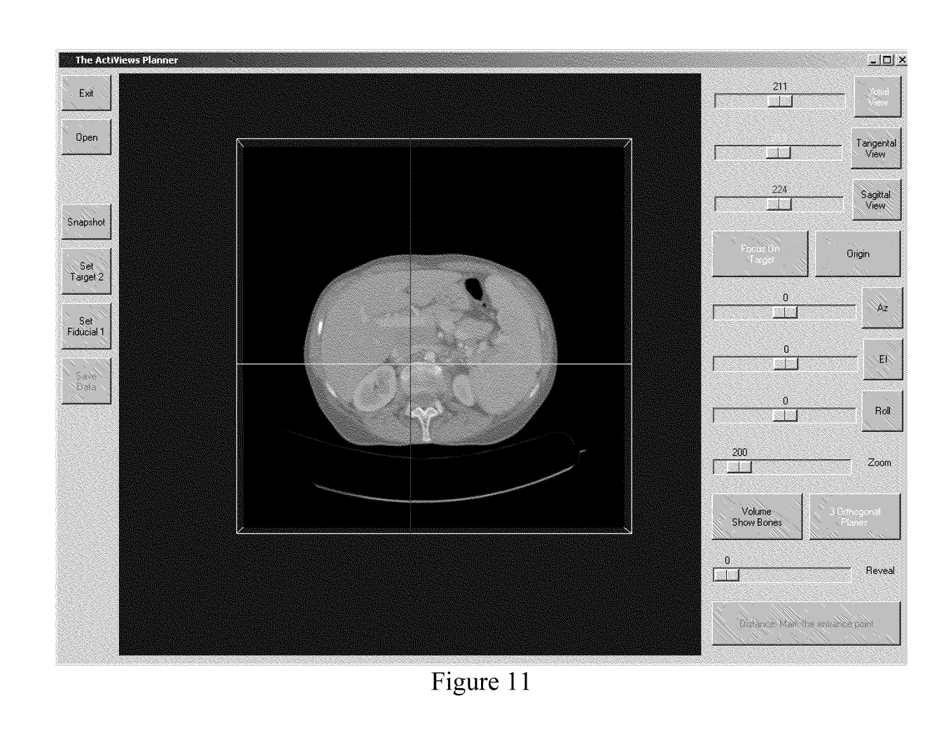

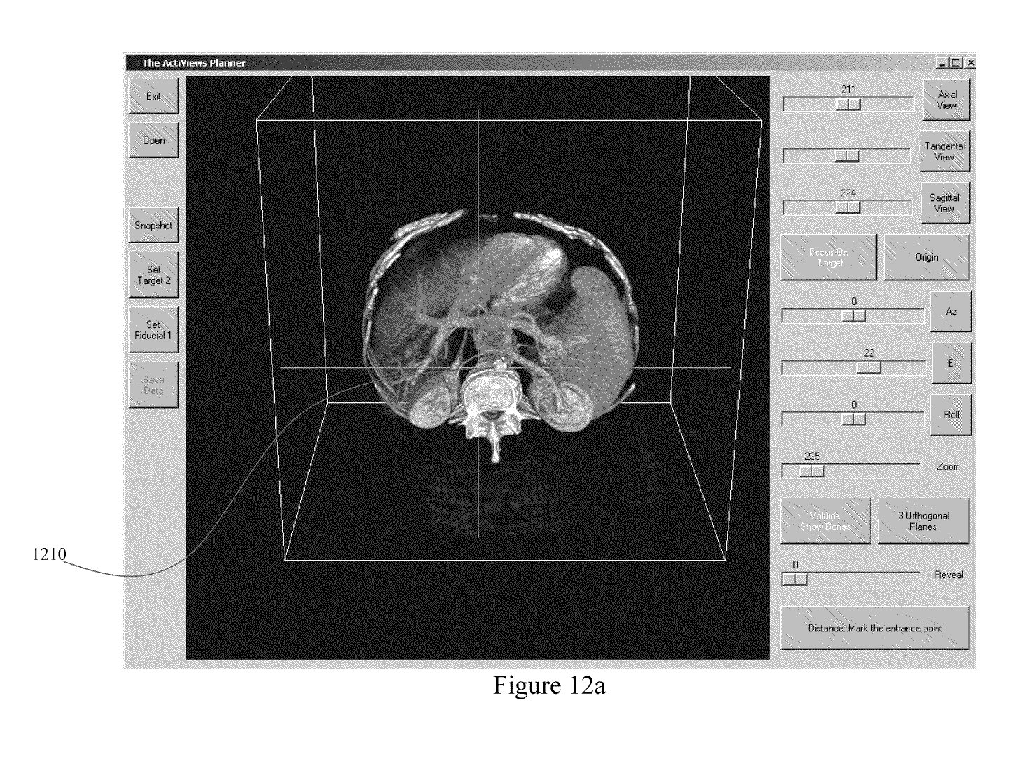

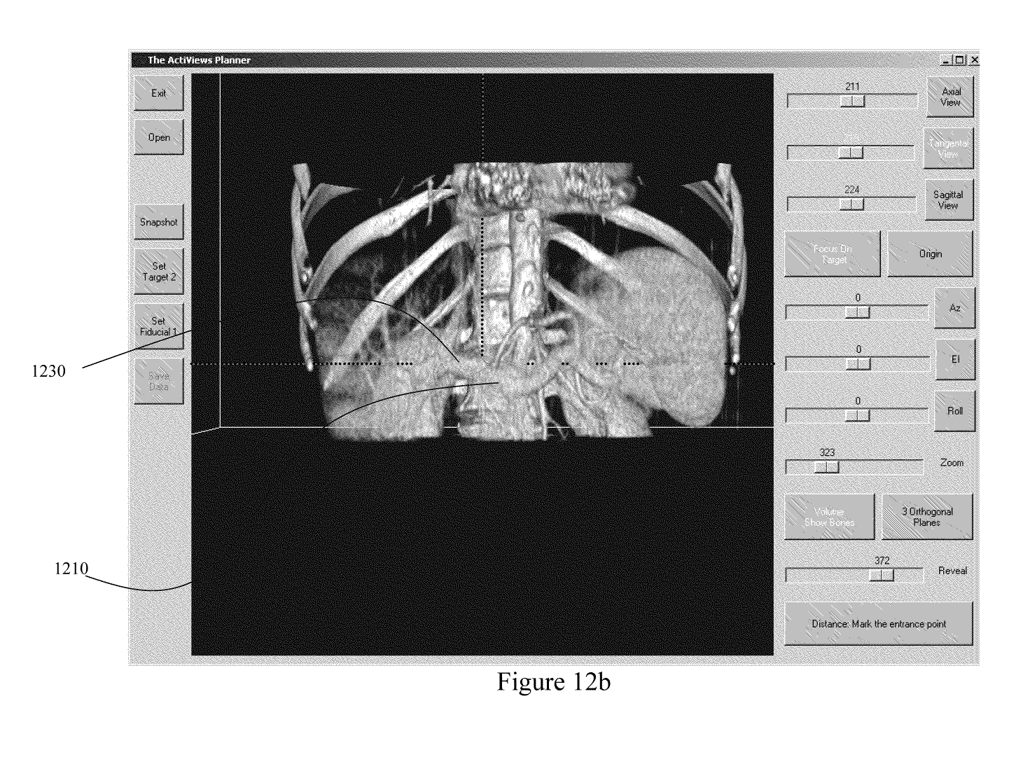

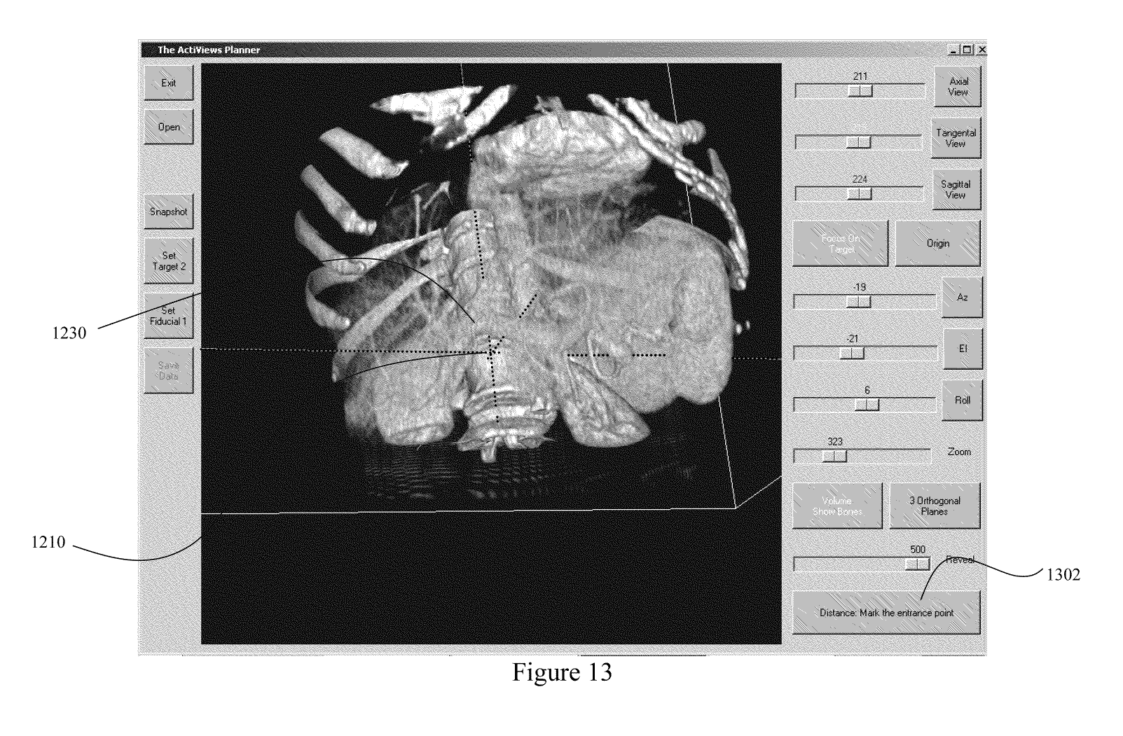

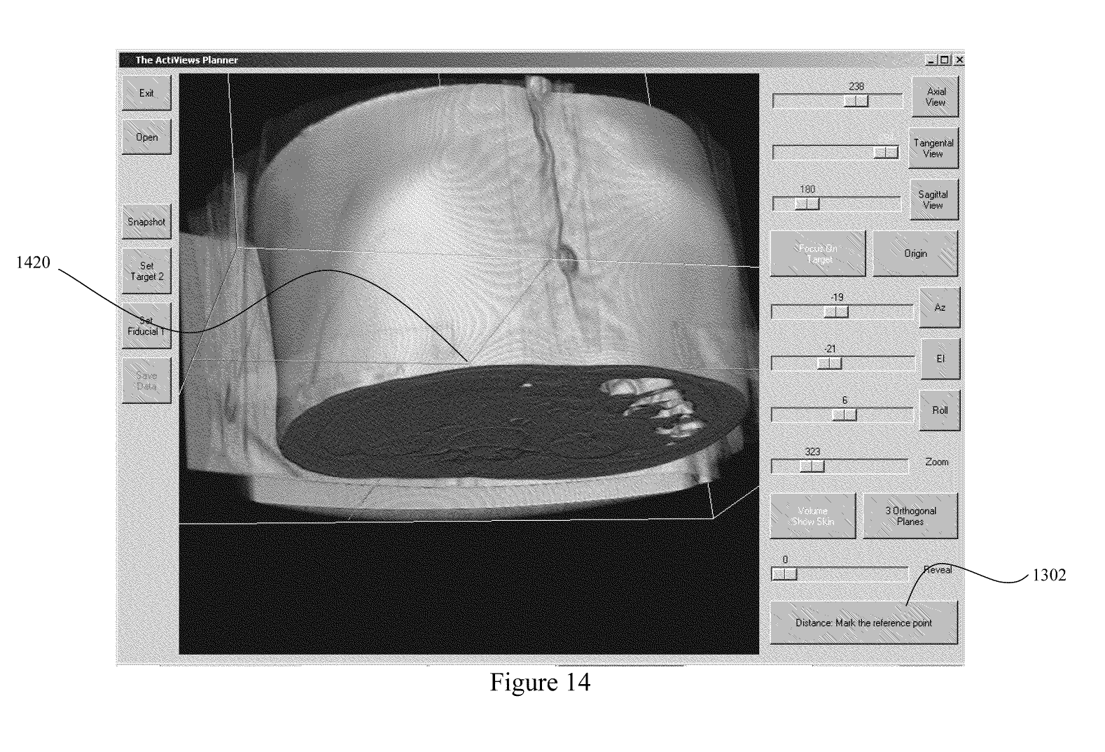

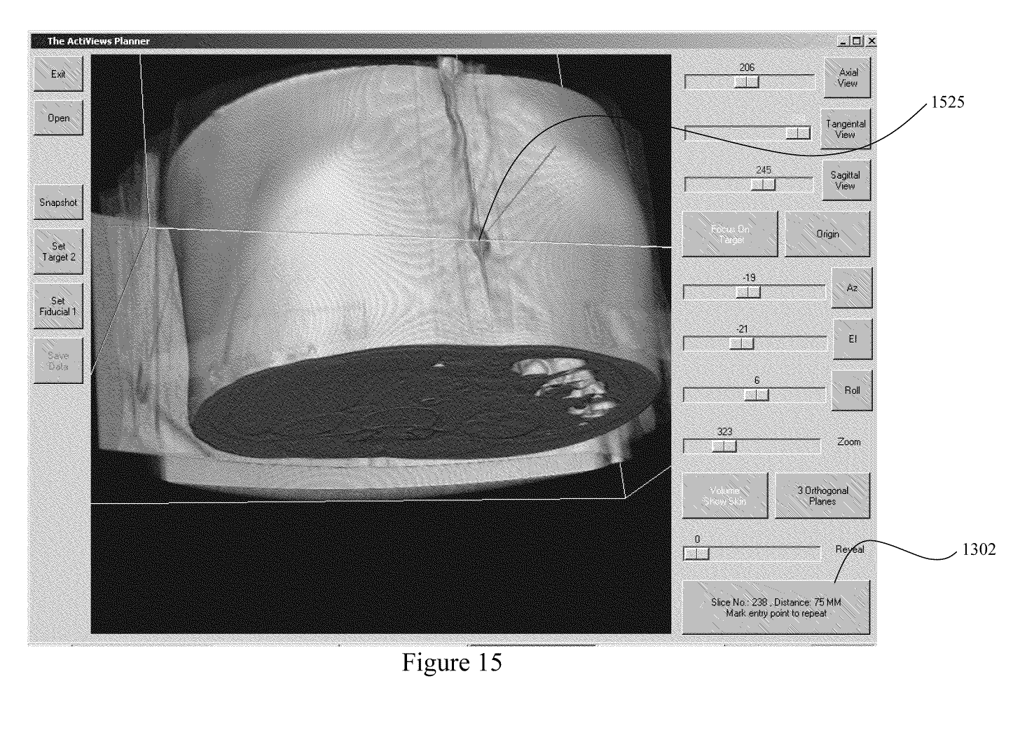

A second example, demonstrating how this method and system may assist to avoid damage to internal vital organs, is shown in FIGS. 10 to 17. In this example, a contrast agent for enhancing the image of the blood vessels under CT, is injected to the patient prior to the procedure. The target is selected (FIG. 10) and centered (FIG. 11). Volume rendering image of the blood vessels is displayed (FIG. 12a). The body is rotated around target 1210 to the orientation which is the preferred for guiding the needle to the target, as shown in FIG. 12b. If this route were to be used, the needle would puncture a major blood vessel 1230, which might result in potentially life threatening bleeding. To avoid this risk, the graphic representation of the body is further rotated until artery 1230 no longer lies within the line of sight to the target, as shown in FIG. 13, corresponding to selection of a corresponding low-risk route. Using button 1302, entry point 1420 is defined as the intersection of the planed route and the skin of the patient, shown in FIG. 14. Reference point 1525 is marked by button 1302. The coordinates of the entry point, defined by slice 238 and distance 75 mm from the reference point is shown in FIG. 15.

To mark the entry point on the skin of the patient, the CT bed is moved to slice number 238. The line projector 110 projects line 1612 on the body of the patient. The clinician has to measure radius 1625 of 75 mm from reference point 1620 and define the intersection 1610 with the projected line. This intersection is the planned entry point.

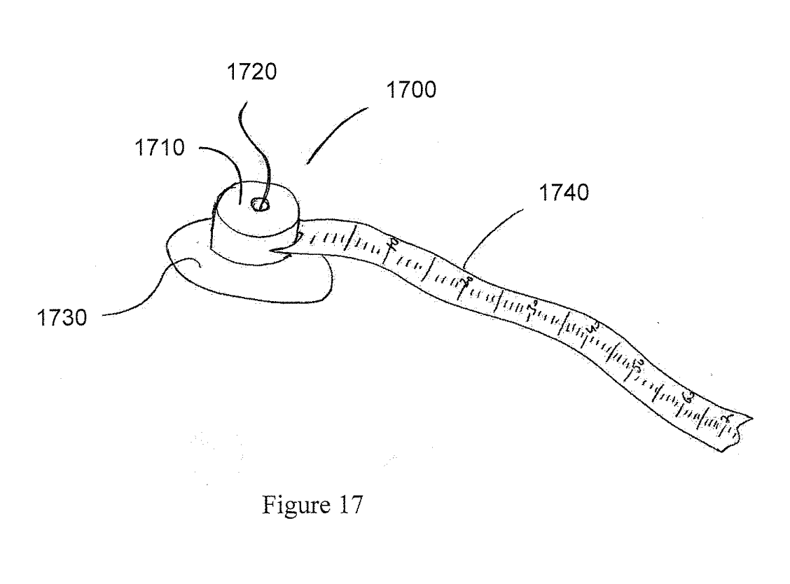

In one preferred embodiment of the invention, radius 925 in example 1 and radius 1625 in example 2 may be measured using a ruler. In another preferred embodiment of the invention, a special marker is used. FIG. 17 illustrates a preferred embodiment of such marker. Marker 1700 comprises a radio-opaque disk 1710. The disk may rotate on a pivot 1720. A flexible ruler or tape-measure 1740 is attached to the disk, so the ruler can be deployed in any required direction, and the distance from the marker can be easily measured. A sticker 1730 is attached to the bottom of the marker. At the beginning of the procedure, marker 1700 is attached to the skin of the patient by sticker 1730. During the planning phase, the distance from the marker to the entry point is determined as described. For marking the entry point on the patient's skin, the ruler 1740 is directed around pivot 1720 and deployed in the general direction of the entry point. The distance from the marker is simply read from the markings on the ruler. The intersection of the determined distance and the projected line on the body of the patient defines the required entry point.

According to an aspect of certain embodiments of the present invention, the method, system and computer product are implemented for use to advantage with a CT scanner with a tiltable gantry. Many existing CT scanners are provided with a tiltable gantry which allows the operator to select an angle of inclination of the image slices. At the conclusion of the planning procedure as described above, the system preferably provides an output indicating the tilt angle of the gantry required so that the planned insertion route lies within a single imaging slice plane. The output may either be a numerical output to the operator for manual tilt operation of the gantry, or may be a direct output command to the CT scanner for automated or semi-automated control of the gantry tilt mechanism. Optionally, the tilt angle limitations of the gantry (for example, ±30°) may be introduced into the planning software as a criterion presented to the user during the planning process, warning the user if he exceeds the range of angles for which gantry alignment can be achieved.

Coordination of the angle of the CT scanner gantry with the planned insertion route may provide one or more advantage. In some cases, where no needle guidance system is used during performance of the procedure, the clinician may use the slice line projector of the CT scanner to facilitate correct alignment of the needle. Specifically, after the needle tip is brought into contact with the insertion point as described above, the angle of the needle can be manually adjusted until the head or shaft of the needle reflects the projected line illumination, thereby indicating that the length of the needle is aligned within the correct plane.

In some cases, a verification CT scan is performed to assess whether the needle is progressing along the correct path or has reached the correct target. Where the CT scanner gantry has been aligned with the planned insertion path, the entire length of the needle is typically visible in a single CT image slice, such that its direction and location, as well as its extrapolated path, can be easily and accurately verified, without requiring tracing the needle through multiple slices.

In the above two examples, the route of the needle is defined as the vector perpendicular to the screen and intersecting with the target. Body organs are displayed in 3D volume rendering images. In other embodiments, other direction and other type of images can be used instead of, or in addition to, the line-of-sight view. For instance, in another preferred embodiment of the invention, two perpendicular 2D cross-sectional images of the body are used, where the line of the intersection between these images is the planned needle route. This route is marked by a line on these two images. In yet another preferred embodiment, one or more 3D volume rendering images viewed from a perpendicular direction to the needle route, or at another angle oblique to the route, are used to identify any vital organs lying on the planned route.

It will be appreciated that the above descriptions are intended only to serve as examples, and that many other embodiments are possible within the scope of the present invention as defined in the appended claims.

What is claimed is:

1. A method for planning a needle procedure in which a needle is to be inserted from an entry point to an intra-body target within the body of a subject, the method comprising the steps of:
(a) inputting three-dimensional image data of the body;
(b) designating within the three-dimensional image data a target location;
(c) defining a tentative route for insertion of the needle to the target location;
(d) processing the three-dimensional image data to generate a first graphic representation of the image data for presentation to a user, said first graphic representation being indicative of whether said tentative route intersects an obstacle of at least one type; and
(e) responsive to a user input, generating at least one additional graphic representation of the image data for presentation to the user, said additional graphic representation being related to said first graphic representation by rotation about at least one axis passing through said target location such that a position of said target location within said graphic representations is substantially constant, thereby allowing selection of an updated route to the target which does not intersect an obstacle of the at least one type.

2. The method of claim 1, wherein said first graphic representation of the image data for presentation to a user corresponds to a view taken substantially parallel to said tentative route in which at least a first type of tissue is rendered transparent, thereby indicating whether said tentative route intersects an obstacle of at least a second type of tissue.

3. The method of claim 1, wherein said three-dimensional image data is of a type selected from the group consisting of CT data and MRI data.

4. The method of claim 1, wherein said obstacle is a non-penetrable tissue type.

5. The method of claim 1, wherein said obstacle is a penetrable internal organ.

6. The method of claim 1, wherein said tentative route and said updated route are straight lines from a needle entry point to the target.

7. The method of claim 1, further comprising determining a needle entry point corresponding to a point of intersection between said updated route and a skin surface identified from said three-dimensional image data.

8. The method of claim 7, further comprising identifying in said three-dimensional image data at least one reference point identifiable on the skin surface, and determining a distance from said at least one reference point to said needle entry point.

9. The method of claim 8, wherein said reference point corresponds to a marker applied to the skin of the subject prior to sampling of said three-dimensional image data.

10. The method of claim 8, further comprising marking said needle entry point on the skin of the user by measuring said distance from said at least one reference point.

11. The method of claim 1, further comprising generating an output indicative of an angle of deployment of at least part of an imaging system for which said updated route lies within an imaging plane of the imaging system.

12. A system for planning a needle procedure in which a needle is to be inserted from an entry point to an intra-body target within the body of a subject, the system comprising:
(a) a display;
(b) a user input device; and
(c) a processor system associated with said display and said user input device, said processor system including at least one processor, said processor system being configured to:
(i) receive three-dimensional image data of the body;
(ii) input via said input device designation within the three-dimensional image data of a target location;
(iii) define a tentative route for insertion of the needle to the target location;
(iv) process the three-dimensional image data to generate a first graphic representation of the image data for presentation via said display to a user, said first graphic representation being indicative of whether said tentative route intersects an obstacle of at least one type; and
(v) responsive to a user input from said input device, generate at least one additional graphic representation of the image data for presentation via said display to the user, said additional graphic representation being related to said first graphic representation by rotation about at least one axis passing through said target location such that a position of said target location within said graphic representations is substantially constant, thereby allowing selection of an updated route to the target which does not intersect an obstacle of the at least one type.

13. The system of claim 12, wherein said first graphic representation corresponds to a view taken substantially parallel to said tentative route in which at least a first type of tissue is rendered transparent, thereby indicating whether said tentative route intersects an obstacle of at least a second type of tissue

14. The system of claim 12, wherein said three-dimensional image data is of a type selected from the group consisting of CT data and MRI data.

15. The system of claim 12, wherein said obstacle is a non-penetrable tissue type.

16. The system of claim 12, wherein said obstacle is a penetrable internal organ.

17. The system of claim 12, wherein said tentative route and said updated route are straight lines from a needle entry point to the target.

18. The system of claim 12, wherein said processor system is further configured to generate an output indicative of an angle of deployment of at least part of an imaging system for which said updated route lies within an imaging plane of the imaging system.

19. A computer readable medium having stored thereon computer readable program code for planning a needle procedure in which a needle is to be inserted from an entry point to an intra-body target within the body of a subject, execution of the program code by a computer being operable to:
(a) receive three-dimensional image data of the body;
(b) input from a user designation within the three-dimensional image data of a target location;
(c) define a tentative route for insertion of the needle to the target location;
(d) process the three-dimensional image data to generate a first graphic representation of the image data for presentation to a user, said first graphic representation being indicative of whether said tentative route intersects an obstacle of at least one type; and
(e) responsive to a user input, generate at least one additional graphic representation of the image data for presentation to the user, said additional graphic representation being related to said first graphic representation by rotation about at least one axis passing through said target location such that a position of said target location within said graphic representations is substantially constant, thereby allowing selection of an updated route to the target which does not intersect an obstacle of the at least one type.

20. The computer readable medium of claim 19, wherein said first graphic representation corresponds to a view taken substantially parallel to said tentative route in which at least a first type of tissue is rendered transparent, thereby indicating whether said tentative route intersects an obstacle of at least a second type of tissue

21. The computer readable medium of claim 19, wherein said three-dimensional image data is of a type selected from the group consisting of CT data and MRI data.

22. The computer readable medium of claim 19, wherein said obstacle is a non-penetrable tissue type.

23. The computer readable medium of claim 19, wherein said obstacle is a penetrable internal organ.

24. The computer readable medium of claim 19, wherein said tentative route and said updated route are straight lines from a needle entry point to the target.

25. The computer readable medium of claim 19, wherein execution of the program code by a computer is further operable to generate an output indicative of an angle of deployment of at least part of an imaging system for which said updated route lies within an imaging plane of the imaging system.
